(19) United States
(12) Patent Application Publication
(10) Pub. No.: US 2016/0369984 A1
(43) Pub. Date: Dec. 22, 2016

(54) VISUAL INDICATING DEVICE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: JIE LI, Wuhan (CN); SHEN-FA TSAI, New Taipei (TW)

(21) Appl. No.: 14/789,003

(22) Filed: Jul. 1, 2015

(30) Foreign Application Priority Data
Jun. 16, 2015 (CN) 201510331548.9

(51) Int. Cl. F21V 21/002; H01H 13/02; F21V 23/06

(52) U.S. Cl. CPC F21V 21/002; F21V 23/06; H01H 13/023; F21Y 2101/02

(57) ABSTRACT

An indicating device includes a light source and an enclosure which is integrated with the light source. The enclosure defines a receiving space for the light source. An opening is defined in the enclosure and communicates with the receiving space. When the light source is received in the receiving space, the enclosure provides a partial shield allowing light from the source to be transmitted and escape only through the opening.

### FIELD

The subject matter herein generally relates to indicating devices.

### BACKGROUND

Illuminated devices, such as illuminated buttons, are employed in many electronic devices. For example, a typical personal computer has power buttons. Each of the power buttons includes a panel and a built-in backlight which is often a light emitting diode (“LED”). Light beams transmitted from the LED can pass out of the power button. That is, when power is on, the LED emits light to make a user aware of the “power on” status of the computer and/or the display.

### BRIEF DESCRIPTION OF THE DRAWINGS

Implementations of the present technology will now be described, by way of example only, with reference to the attached figures.

FIG. 1 is an isometric view of an embodiment of an indicating device.

FIG. 2 is an exploded, isometric view of the indicating device of FIG. 1 used in a circuit board.

FIG. 3 is similar to FIG. 2, but the indicating device is viewed from a different angle.

FIG. 4 is an assembled view of the indicating device and the circuit board of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to an indicating device. The indicating device includes an indicating lamp an enclosure integrated with the indicating lamp. The enclosure defines a receiving space used to receive the indicating lamp. An opening is defined in the enclosure and communicates with the receiving space. When the indicating lamp is received in the receiving space, the enclosure partially shields the indicating lamp allowing light from the indicating lamp to be transmitted and escape only through the opening.

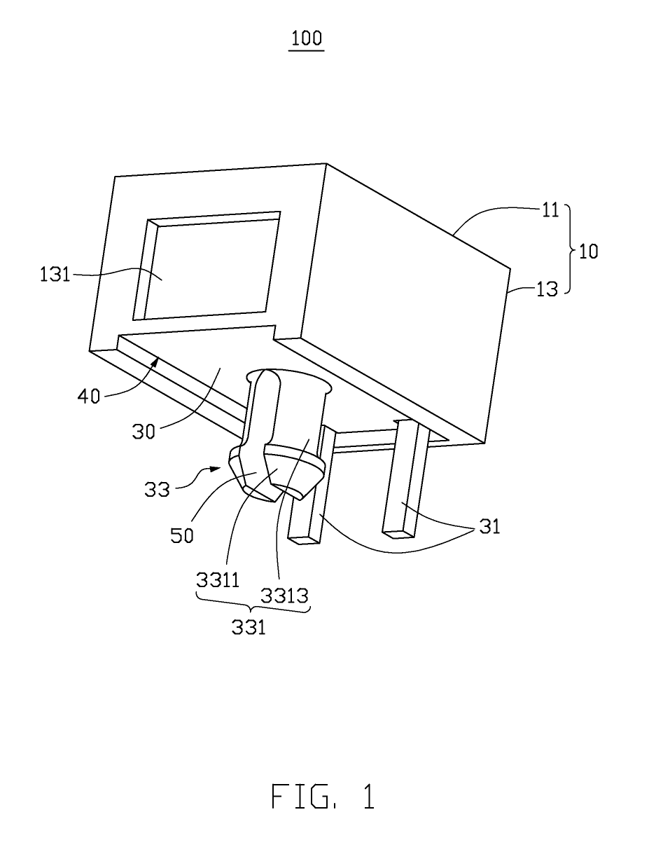

FIG. 1 illustrates an embodiment of an indicating device 100. The indicating device 100 includes an enclosure 10 and an indicating lamp 30 can be received in the enclosure 10. In at least one embodiment, the indicating lamp 30 is integrated with the enclosure 10.

The enclosure 10 can include a top panel 11 and four side panels 13 extending from the top panel 11. In at least one embodiment, the top panel 11 can be rectangular, and the four side panels 13 extend from four edges of the top panel 11. A receiving space 40 can be defined by the top panel 11 and the four side panels 13. An opening 131 is defined in one of the four side panel 13 and is configured to allow light emitted by the indicating lamp 30 to be emitted out of the enclosure 10 via the opening 131.

Two coupling pins 31 and a clipping member 33 are located on a bottom portion of the indicating lamp 30. The clipping member 33 includes two elastic clipping pieces 331 with a gap 50 therebetween. Each clipping piece 331 can include an extending portion 3311 extending from the bottom portion of the indicating lamp 30 and a clipping portion 3313 coupled to the extending portion 3311. In at least one embodiment, a width of the clipping portion 3313 is greater than a width of the extending portion 3311.

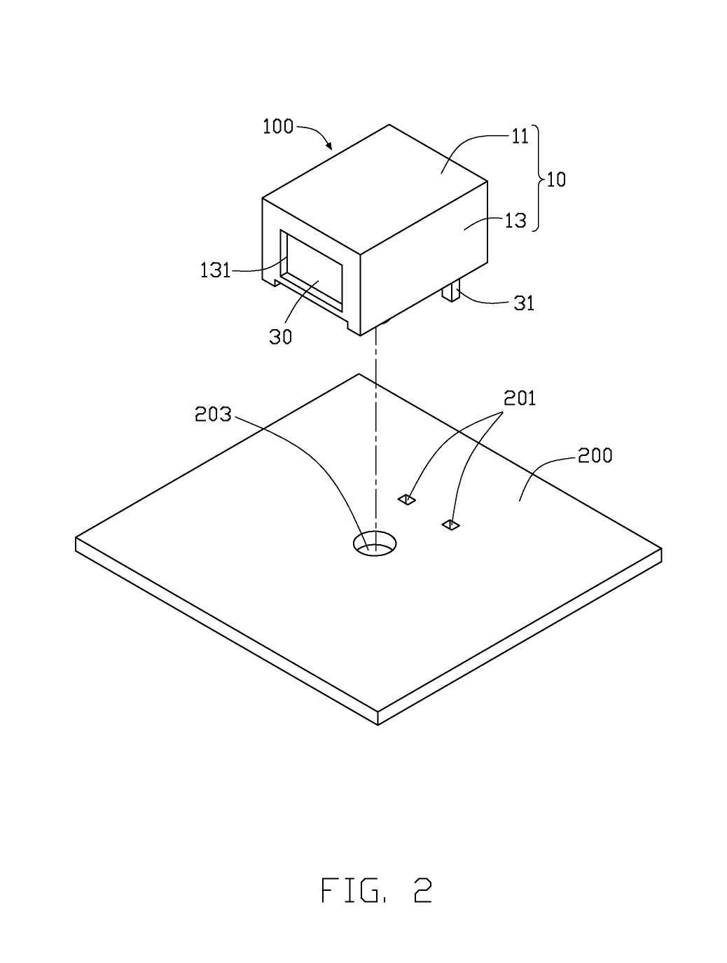

FIG. 2 illustrates the indicating device 100 being used in a circuit board 200. The circuit board 200 can define two coupling holes 201 and a clipping hole 203. The two coupling holes 201 correspond to the two pins 31, and the clipping hole 203 can receive the clipping member 331.

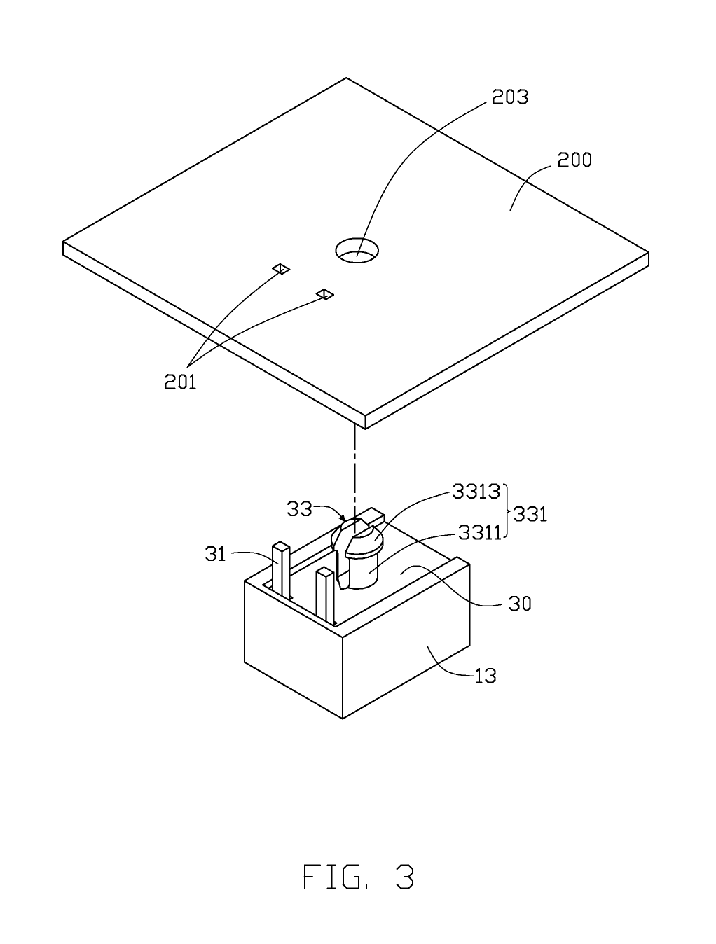

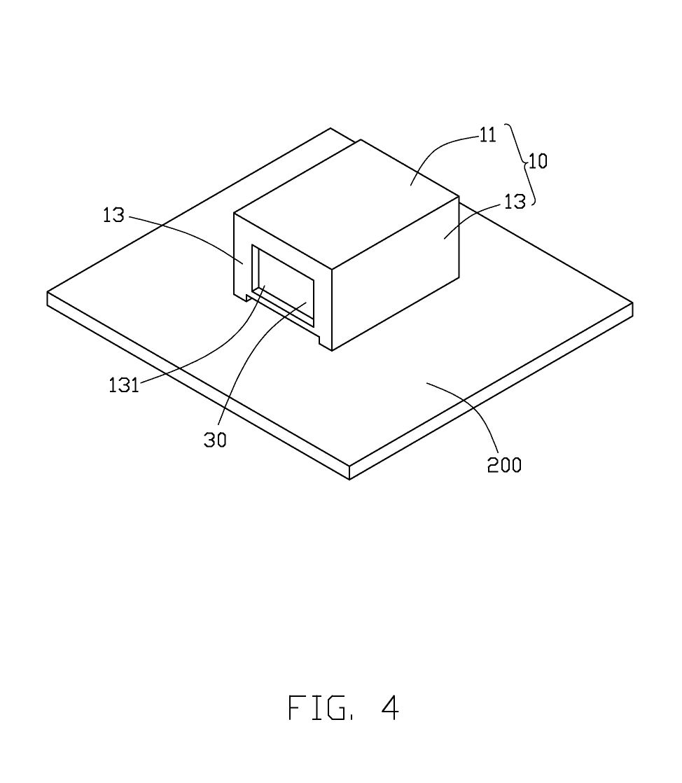

FIGS. 3 and 4 illustrate the indicating device 100 being secured to the circuit board 200. In assembly, the indicating device 100 is located on the circuit board 200, and the two clipping pieces 33 deform to pass into the clipping hole 203. When the two clipping pieces 33 extend through the clipping hole 203, the two clipping pieces 33 are released to latch with a bottom portion of the circuit board 200. The two pins 31 are engaged in the two coupling holes 201, so that the indicating lamp 100 can be electronically coupled to the circuit board 200 and the circuit board 200 can supply power for the indicating lamp 30. The indicating lamp 30 is shielded by side panels 13 of the enclosure 10, so almost all the light emitted by the indicating lamp 30 will pass out of the enclosure 10 via the opening 131.

The embodiments shown and described above are only examples. Many details are often found in the art such as the other features of an indicating device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An indicating device comprising:
an indicating lamp;
an enclosure defining a receiving space; the receiving space configured to receive the indicating lamp, an opening defined in the enclosure and communicating with the receiving space; and
wherein when the indicating lamp is received in the receiving space, the enclosure partially shields the indicating lamp allowing light from the indicating lamp to be transmitted only through the opening.

2. The indicating device of claim 1, wherein the enclosure comprises a top panel and four side panels extending from the top panel, and the receiving space is defined by the top panel and the four side panels.

3. The indicating device of claim 2, wherein the opening is defined in one of four side panels.

4. The indicating device of claim 1, wherein two pins are located on the indicating lamp, and the two pins are configured to electronically coupled to a circuit board.

5. The indicating device of claim 4, wherein a clipping member is located on the indicating lamp, and the clipping member is engaged in a clipping hole of the circuit board to secure the indicating lamp to the circuit board.

6. The indicating device of claim 5, wherein the clipping member comprises opposite clipping pieces, and a gap is defined by the opposite clipping pieces.

7. The indicating device of claim 6, wherein each clipping piece comprises an extending portion extending from the indicating lamp and a clipping portion coupled to the extending portion, and a width of the clipping portion is greater than a width of the extending portion.

8. The indicating device of claim 1, wherein the indicating lamp is a light emitting diode.

9. An indicating device comprising:
an indicating lamp; and
an enclosure integrated with the indicating lamp and comprising a top panel and a plurality of side panels extending from the top panel, an opening defined in the enclosure and communicating with the receiving space; wherein the indicating lamp is received in the enclosure and is shielded by the top panel and a plurality of panels, and light from the indicating lamp is transmitted out of the enclosure only through the opening.

10. The indicating device of claim 9, wherein a receiving space is defined by the top panel and the four side panels, and the indicating lamp is received in the receiving space.

11. The indicating device of claim 9, wherein the opening is defined in one of plurality of side panels.

12. The indicating device of claim 9, wherein two pins are located on the indicating lamp, and the two pins are configured to electronically coupled to a circuit board.

13. The indicating device of claim 12, wherein a clipping member is located on the indicating lamp, and the clipping member is engaged in a clipping hole of the circuit board to secure the indicating lamp to the circuit board.

14. The indicating device of claim 13, wherein the clipping member comprises opposite clipping pieces, and a gap is defined by the opposite clipping pieces.

15. The indicating device of claim 14, wherein each clipping piece comprises an extending portion extending from the indicating lamp and a clipping portion coupled to the extending portion, and a width of the clipping portion is greater than a width of the extending portion.

16. The indicating device of claim 9, wherein the indicating lamp is a light emitting diode.
